(19) United States
(12) Patent Application Publication
(10) Pub. No.: US 2010/0318343 A1
(43) Pub. Date: Dec. 16, 2010

(54) SMART DATA ACCESS LAYER FOR SUPERVISORY INFORMATION SYSTEM

(75) Inventors: Jiang Wei, Shanghai (CN); Chen Zhou Ye, Shanghai (CN); Chuanzheng Cai, Shanghai (CN); Hui Sun, Shanghai (CN); Ming Ge, Shanghai (CN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/738,913

(22) PCT Filed: Oct. 31, 2007
(86) PCT No.: PCT/CN2007/003101

§ 371 Date: Aug. 23, 2010

(51) Int. Cl. G06F 17/50

(52) U.S. Cl. 703/18

(57) ABSTRACT

One embodiment of the application provides a method and system for selecting a template characterizing a power plant from a template base, the template base including a plurality of templates and creating a power plant model of the power plant using the first template, the power plant model including a plurality of modules arranged in a hierarchical tree array having at least one tree branch, wherein each of the plurality of modules includes a plurality of attributes of the power plant that are arranged to be accessed by a data access layer using a tag name which includes names of ancestor modules in the tree branch. Additionally, the method and system also provides for mapping the plurality of attributes to specific applications of the power plant using the data access layer and configuring the power plant with the plurality of attributes using the data access layer.

### TECHNICAL FIELD

The present application relates generally to the technical field of supervisory information system.

### BACKGROUND

Supervisory information systems are used by power generating companies to access data associated with various components of power plants.

Often operating personnel need to intervene during installation, configuration and maintenance of the power plant. The detailed design and actual construction of power plants varies a great deal from plant to plant. Improving data quality and security between the supervisory information system and the power plant is desired.

### BRIEF DESCRIPTION OF THE DRAWINGS

Some embodiments are illustrated by way of examples, and not by way of limitations, in the figures of the accompanying drawings in which:

FIG. 1 is a block diagram illustrating the configuration of a supervisory information system, according to an example embodiment.

FIG. 2 illustrates a schematic diagram of the architecture of a supervisory information system, according to an example embodiment.

FIG. 3 is a block diagram illustrating a Smart Data Access Layer (SDAL), according to an example embodiment.

FIG. 4 is a flowchart illustrating a method for configuring a power plant using the SDAL, according to an example embodiment.

FIG. 5 is a schematic diagram illustrating configuring a hierarchical plant model of a power plant, according to another example embodiment.

FIG. 6 is a block diagram illustrating a machine in the example form of a computer system, within which a set of sequence of instructions for causing the machine to perform any one of the methodologies discussed herein may be executed.

### DETAILED DESCRIPTION

In the following description, for purposes of explanation, numerous specific details are set forth in order to provide a thorough understanding of example embodiments. It will be evident, however, to one skilled in the art that the embodiments of the application may be practiced without these specific details.

Supervisory information systems are used by power generating companies to improve the plant-wide operating efficiency. Supervisory information systems are designed to manage, monitor and optimize the overall performance of a power plant. As the size of the supervisory information system becomes increasingly large, heavy information load occurs for both supervisory information system developers and engineers who configure and maintain all the tools associated with monitoring and managing the power plant. Conventional supervisory information systems suffer from a problem of requiring substantial intervention by operating personnel during installation, configuration and maintenance of the power plant because the detailed design and actual construction of power plants varies a great deal from plant to plant. Additionally, different brands of databases are available in the market and any one of them may be used by a given power plant. Identical parameters from different power plants can be assigned different names or different units. Hence, an improved system and method of information sharing that simplifies implementation, installation, configuration and maintenance steps for a power plant is desired. Furthermore, improved data quality and security of the data communicated between the supervisory information system and the power plant is desired.

In some embodiments, a smart data access layer is provided for the supervisory information system. One of the functions of the smart data access layer includes alleviating information (or data) overload that can occur during implementation, installation, configuration and maintenance steps of a power plant. A power plant model organizing all of the power plant features in a hierarchical manner can be built from a pre-established template with minor modifications and extensions. Applications or subsystems of the supervisory information system can access plant information using standard hierarchical names through a uniform interface that can perform additional data pre-processing and post-processing functions such as automatic unit and type transformation, data validation, read/write protection etc. Services like licensing, logging, alarming and running status monitoring are also available for application running above the smart data access layer. Moreover, the smart data access layer enhances data quality and security, improves information sharing and facilitates advanced applications.

In some embodiments, the smart data access layer disclosed herein includes a plant model that organizes all SIS-needed plant features in a hierarchical manner. This plant model can be built using a pre-established template with minor modifications and extensions. Applications or subsystems of the supervisory information system can access plant information using standard hierarchical names through a uniform interface that can perform additional data pre-processing and post-processing functions such as automatic unit and type transformation, data validation, read/write protection etc. In some embodiments, services such as licensing, logging, alarming and running status monitoring are also available for application running above the smart data access layer.

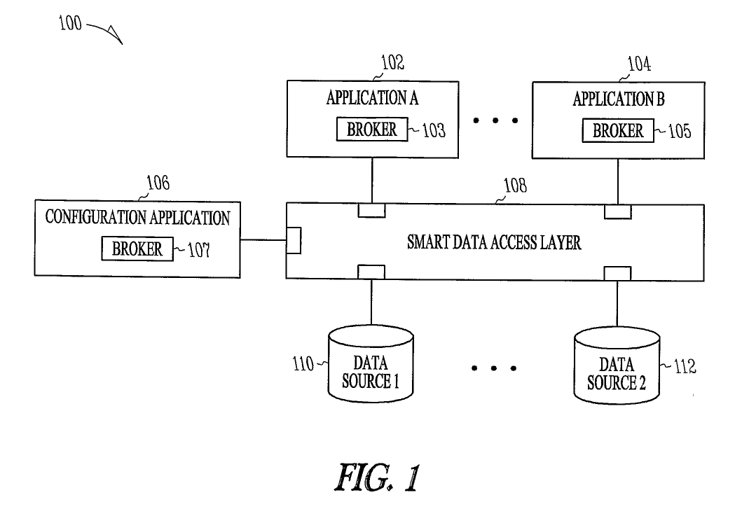

FIG. 1 is a block diagram illustrating the configuration of a supervisory information system 100, according to an example embodiment. Supervisory information system 100 includes applications 102, 103, a configuration application 106, data sources 110, 112 and a smart data access layer 108. Applications 102, 104 include brokers 103, 105, respectively and configuration application 106 includes a broker 107. Each of applications 102, 104 and configuration application 106 are coupled to smart data access layer 108. Additionally data sources 110,112 are also coupled to smart data access layer 108. Each of applications 102, 104 and 106 communicates with the smart data access layer 108 using brokers 103, 105 and 107, respectively. In some embodiments, the smart data access layer 108 provides a visualization tool including a display the power plant model in order to search feature names matching key words given by the user. In some embodiments, the supervisory information system can automatically configure the power plant during turn-up. Any changes in the data sources 110, 112 will not affect SIS applications interfacing with the smart data access layer 108.

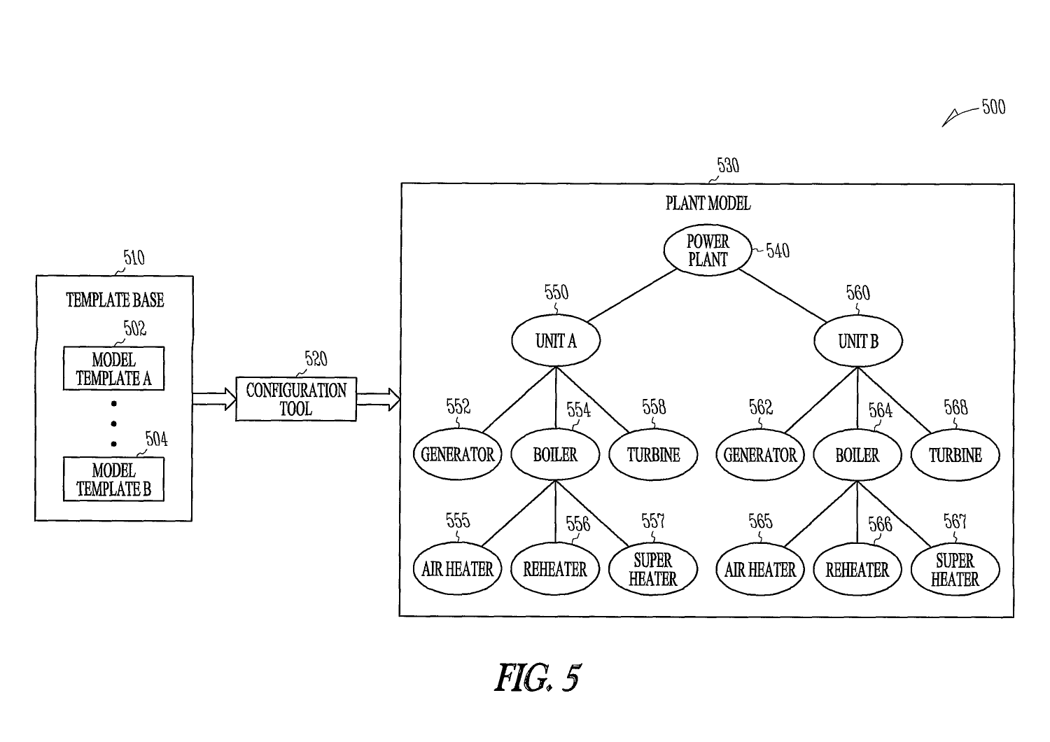

The smart data access layer 108 employs a Extensible Markup Language (XML) based utility to share basic or public information of the plant model among all supervisory information system tools (see FIG. 4). In some embodiments, smart data access layer 108 and supervisory information system applications are executed on different machines. When a supervisory information system application wants to browse the plant model, it will be inefficient to setup a session between the application and the data access layer to handle the quite intensive interactions between them over the network. Instead, in some embodiments, when a supervisory information system application sends to the smart data access layer 108 a valid request to retrieve model information, an XML file describing public information of the plant model will be generated by the XML parser at the data access layer side and transferred to the application through a network. Then the application can retrieve model information locally after the private and simplified copy of the plant model has been reconstructed from the XML file by the local XML parser.

In some embodiments, the smart data access layer 108 provides a uniform data access interface that can perform not only basic data read and writing but also functions like automatic unit and type transformation, data validation, read/write protection etc. for supervisory information system applications or subsystems. As mentioned earlier, variables of the same physical meaning can take different rates/code tables/data types for different power plants or even different generating units in the same plant while supervisory information system tools usually take a default rate/code table/data type for that variable. An inconsistence can occur if the actual definition is not identical to the default one. In some embodiments, to prevent potential errors caused by this type of inconsistence, the smart data access layer can automatically convert the feature value of plant definition to a default value during data read and also during data writing. In some embodiments, both the plant definitions and the default values need to be defined during configuration of the smart access layer.

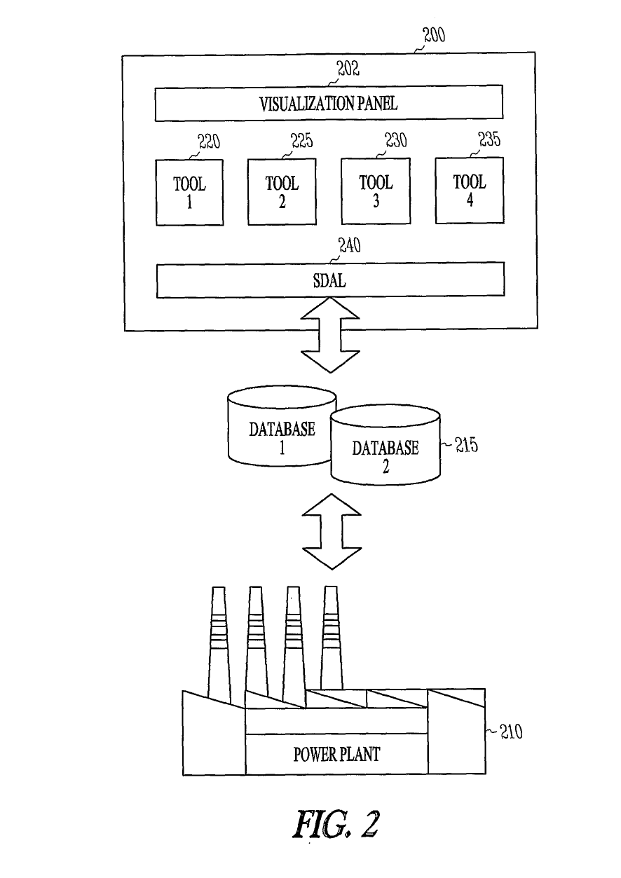

FIG. 2 illustrates a schematic diagram of a supervisory information system 200, according to an example embodiment. In some embodiments, the supervisory information system 200 illustrated herein generally may be used to manage, monitor and optimize the overall performance of a power plant 210 (coal fired, combined cycle, etc.). Supervisory information system 200 includes a visualization panel 202, multiple software modules or tools 220, 225, 230, and 235 to calculate and monitor performance of the power plant 210 at both component level and system level, and give optimization recommendations to different parts of the power plant. The tools retrieve the data from database 215 through smart data access layer (SDAL) 240, perform some kind of calculation, monitoring, or optimization and then send the calculation results to the visualization panel 202. In some embodiments, visualization panel 202 can be a common component shared by all supervisory information system tools as shown in FIG. 2 or a dedicated one attached to every tool independently. Additionally results of various calculations are sent back to the database for storage using the smart data access layer 240.

In some embodiments, the various tools 220, 225, 230 and 235 can include any one of a visual model system, a boiler cleanliness monitor, a steady state combustion optimization system, a unit life management system, device degradation detection and diagnosis system, a statistical analyzer or a process history database.

The visual model system 202 interfaces with smart data access layer 240 and provides for a physical model of the entire power plant including boilers, turbines, regenerative cycles etc. In some embodiments, visual model system 202 performs system level and component level analysis using a model based reasoning.

In an example embodiment, the database 240 may contain data or information about industrial performance of the power plant. In some example embodiments, the database may contain historical data, real time data, trend parameters, calculation results associated with a industrial performance, e.g., the coal pulverizer current trend. An update device may, for example, update the real time data in the database 222. To facilitate read/write protection, a set of read/write privileges can be assigned to each node of the hierarchical tree during model configuration or editing. Data read/write at a node will be allowed only when the data request can provide all required privileges. Illegal visiting attempts will be recorded by the data access layer and reported to concerned personnel. In this way, data access of a specific supervisory information system tool can be strictly limited within the safe scope determined by the supervisory information system administrators or engineers.

In some embodiments, process history database 222 stores and archives process data and provides for fast retrieval and transformation of data into meaningful information.

In some embodiments, all data read or written through the smart data access layer will be checked according to some rules set by the user. In some embodiments, the data access layer 108 will inform supervisory information system applications about data validation status through the state code returned by the data access interface. In some embodiments, since the data access layer has a table indicating which feature can be read and/or written by which applications, and it is compulsory for a supervisory information system application to afford its application name or identification during initialization of the data interface, it is easy for the data access layer to check whether the data request is authorized or not and inform the application through state code returned by the data interface.

In some embodiments, a user interface provided by the data access layer can warn the supervisory information system administrator about data errors and unauthorized data access operations.

In some embodiments, services like licensing, logging, alarming, and running status monitoring are also available for application running above the layer. Since it is compulsory for a supervisory information system application to afford its application name or ID during initialization of the data interface, and the supervisory information system application can not work without data, using the data access layer as the licensing center is a reasonable choice. In some embodiments, the application status can be reported to the layer through the uniform data interface to facilitate logging and running status monitoring at the layer side.

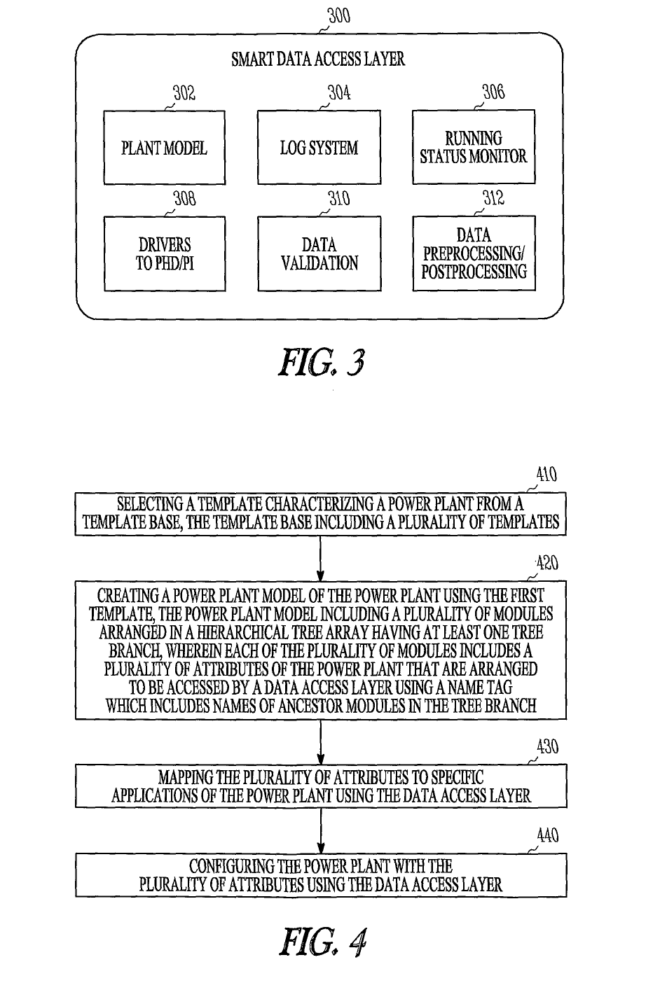

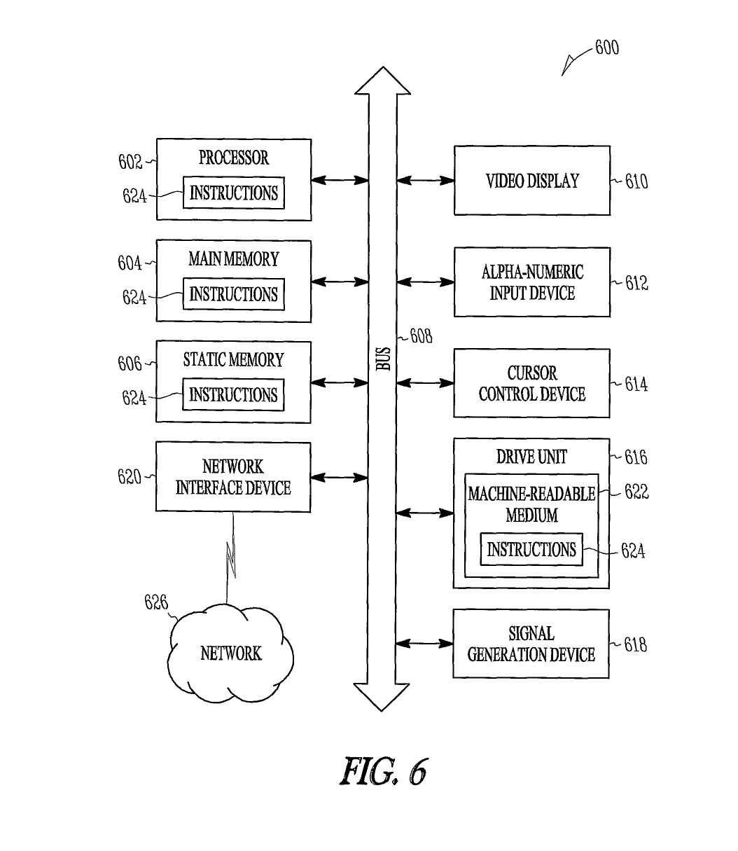

FIG. 3 is a block diagram illustrating a Smart Data Access Layer (SDAL) 300, according to an example embodiment. In some embodiments, the smart data access layer 300 includes plant model 302, log system 304, running status monitor 306, driver module 308 to collect, store and archive data in a process history database, data validation module 310, data pre-processing/post-processing module 312. Plant model 302 includes a hierarchical tree structure of various modules of a power plant as shown in more detail in FIG. 5. In some embodiments, SDAL 300 is configured to perform data validation of all the data communicated between the various systems interfaced with the SDAL 300. In some embodiments, SDAL 300 performs the function of alarming based on monitoring of various parameters of a modules within a power plant. In some embodiments, the running status monitor 306 diagnoses the status of various systems interfacing the SDAL 300. In some embodiments, the data pre-processing/post-processing module 312 performs calculations for changing the units of various parameters. For example, the units may be changed for kilo-Watt-Hour to mega-Watt-Hour. In some embodiments, application status monitoring and event services like alarming, logging, etc. are provided within the smart data access layer 300.

In some embodiments, it is compulsory for a supervisory information system application to register itself with its application ID, name, launch time, etc. using an application status monitoring service at the time when the application is started. Once the registration succeeds, a new entity that records basic information of the application will be created in the monitoring service. In some embodiments, from then on the application needs to send its running status to the service at a certain frequency during its whole running cycle. In some embodiments, whenever the application fails to do this without informing the service that it has been terminated normally, the monitoring service, after waiting a specified length of time, will consider status of the application as “collapsed” and send out an alarming message to the concerned personnel and remove corresponding registration entity after receiving user confirmation. In some embodiments, a user can select different processing functions to be performed by the data pre-processing/post-processing module 312.

FIG. 4 is a flowchart illustrating a method 400 for configuring a power plant using the smart data access layer, according to an example embodiment.

At 410, method 400 includes selecting a template characterizing a power plant from a template base. The template base includes a number of templates representing different power plants.

At 420, method 400 includes creating a power plant model of the power plant using a template selected from the template base. In some embodiments, the power plant model includes a number of modules arranged in a hierarchical tree array having at least one tree branch. In some embodiments, each of the modules includes a number of attributes of the power plant that are arranged to be accessed by a data access layer using a name tag which includes the names of ancestors of ancestor modules in the tree branch. Each of the modules within the power plant model can include a plurality of attributes. In some embodiments, the module template includes a group of features, relevant attributes, which are predefined by a design engineer working on the power plant. For example, in the case of a boiler, “efficiency loss” is one of the module feature composed of several attributes like “Name”, “Type”, “Value”, “Upper Limit”, “Lower Limit”, “Relevant Tag Name”, Description”, “Access Right”, “Data Validation Manner”, “Need Unit Converter”, etc. In some embodiments, the “Description” attribute can include descriptors like “Boiler Energy Balance Efficiency”, “Boiler Input-Output Efficiency”, “Boiler Efficiency Optimization”, “Boiler Control Volume”, “Airside Flow”, etc. All of the above information and attributes for modules can be stored in a database or a file in advance as a predefined template. In some embodiments, the module templates can represents either of a high-pressure turbine rotor, an intermediate-pressure turbine rotor, a low-pressure turbine rotor, a high pressure feed water heater, a low pressure feed water heater, a boiler, a boiler pump, a turbine pump, or a condenser.

In operation, for example, when a configuration engineer needs to provision a new “boiler”, then a new entity (boiler) including its related features will be created in power plant model, according to the definitions specified in the module template. The new entity boiler will be incorporated as part of the hierarchical tree array.

At 430, method 400 includes mapping the plurality of attributes to operating applications of the power plant using the data access layer. In some embodiments, when a new power plant model is created, the settings of the attributes are the predefined default values provided in the template. In such cases, in order to custom fit different type of power plant, a certain amount of modification might be necessary by the power plant configuring personnel.

At 440, method 400 includes configuring the power plant with the plurality of attributes using the data access layer. In some embodiments, method 400 includes processing operating data received from the power plant that is associated with the plurality of attributes using a pre-processing/post-processing module included in the data access layer and displaying the processed data. In some embodiments, method 400 includes communicating with the power plant using the data access layer and retrieving power plant data and performing calculations on the power plant data for the specific applications of the power plant. In some embodiments, method 400 includes providing access privileges for users to access the power plant model using the data access layer. In some embodiments, method 400 includes performing unit transformation of power plant data using the data access layer, wherein unit transformation includes converting the unit of measurement of power plant data between various measuring systems. In some embodiments, method 400 includes performing data validation of power plant data received from the power plant using the data access layer to compare the power plant data to a stored data representing valid data. In some embodiments, method 400 includes configuring the power plant with the plurality of attributes using the data access layer includes using a configuration tool to insert selected attribute data at specific power plant locations designated by the power plant model.

FIG. 5 is a schematic diagram 500 illustrating configuring a hierarchical plant model of a power plant, according to an example embodiment. As mentioned earlier, the central part of smart data access layer is the tree like plant model illustrated in FIG. 5. Instead of setting up the model all from scratch, the user, with the help of the configuration tool, can choose a model temple closest to the target plant from the template base, make minor modifications and extensions to it, map all features to their respective sources, and finally embed it to the data access layer. FIG. 5 includes a template base 510, configuration tool 520 and plant model 530. Template base 510 includes model templates 502 and 504. In some embodiments, template base 510 includes several model templates that represent various types of power plants that need to be configured. Plant model 530 includes various modules arranged in a hierarchical tree structure that is classified under Unit A 550 and Unit B 560. Unit A 550 and Unit B 560 are separated units listed under power plant 540. Unit A 550 has generator 552, boiler 554 and turbine 558 listed below it. Boiler 554 has air heater 555, re-heater 556 and a super heater 557 listed under it. Similarly, Unit B 560 has generator 562, boiler 564 and turbine 568 listed below it. Boiler 564 has air heater 565, re-heater 566 and a super heater 567 listed under it.

In some embodiments, the various modules are arranged in a hierarchical tree pattern such that each of the modules 550-558 and 560-568 are given a tag-name that includes all the names of modules in the tree branch from the power plant to the particular module. In some embodiments, the plant model will have a standard name expressing both its affiliation and physical meaning. For example, one such name could be as follows:

UnitA.Boiler.Reheater.Temperature

In some embodiments, configuration tool 520 enables automatic entering of attributes in the plant model 530 for each of the modules 550-558 and 560-568. In some embodiments, access privileges are defined in each plant model. In some embodiments, during a configuration process of the power plant, the engineer configuring the power plant can choose a template most similar to the real power plant and adapt it to the real construction with minor modifications or extensions.

In some embodiments, the power plant model can be organized in a hierarchical manner to include various power plant features. Although a huge number of tag names will be created for a generating unit to record its working conditions and static attributes (typically, a modern coal fired generating unit can create more than 10,000 tag names in the database), only a small fraction of them (<5%) will be truly needed by conventional supervisory information system applications. In some embodiments, these tag names together with their associated attributes that are created for the supervisory information system would constitute a major portion of the power plant model. In some embodiments, it is possible to organize a relatively small number of power plant features in a more effective and intuitive manner, so that tag names and/or attributes of the same device can be grouped into one block to form the data object for that device. In some embodiments, the physical relationships between different devices can be reflected by the relationships between different data objects. This type of representation makes it easier for supervisory information system developers and engineers to retrieve relevant information and understand their relationship. In some embodiments, advanced applications such as fault diagnosis that requires knowing not only the values of a set data but also the association and/or correlation between them can also benefit from this type of representation. Compared to a network structure that can express linkages between devices in a more complete and efficient way, a tree structure is easier to be configured and manipulated.

In some embodiments, every feature represented in the plant model will have a standard name expressing both its affiliation and physical meaning and point to a specific tag name in the database or other kind of data source. For example, the load demand of “Unit1” can be denoted as “Unit1.LoadDemand”, and the gas temperature at the exit of furnace can be expressed by “Unit1.Furnace.Exit.Gas.Temperature”. They are linked to tag names “AAAAAAAA” and “BBBBBBBB” respectively. Compared to tag name that can be different from generator to generator even for the same feature, the standard name is more regular or even fixed for all plants.

In some embodiments, in order to facilitate easy retrieval of standard feature names, the data access layer affords a tool to visualize the power plant model and to search feature names matching key words given by the user. The tool can list all features of the model in a tree with the “Plant” node as its root node. If the plant owns two generating units (Unit1 and Unit2), the “Plant” node can have “Unit1” and “Unit2” as its child nodes. If a node contains features or sub nodes, it will be displayed as a non-leaf node. If the node only stands for a feature, it will be displayed as a leaf node. User can explore model details to different levels through visiting nodes at different depths. To search for feature names, user can type in the device name the feature belongs to or part of the feature name. For example, if the user wants to know the standard name of the gas temperature at the furnace exit of Unit 1, she or he can start the search with key words like “Unit1.Furnace”, “Gas.Temperature”, “Unit1.Gas.Tempearture” etc.

In some embodiments, instead of directly using tag names to access data, supervisory information system applications running on the data access layer will access data through standard names of features. Using this method, the supervisory information system engineers need only focus on the power plant model which is more concise and more user friendly than the database. Additionally, supervisory information system applications can partially or entirely realize self-configuration. Since the power plant models employ a standard naming system that can assign highly regular names to most of the features, supervisory information system applications can know beforehand which input/output features are always available in the power plant model no matter which power plant it stands for and then “hard link” these inputs/outputs to these features through standard feature names. For example, if an application needs the load of a generating unit as one of its inputs, then when the user type “Unit1” in as the unit name, the application can automatically map the input to “Unit1.Load”. Furthermore, changes in data sources will not affect the supervisory information system applications. Reconfiguration can be avoided when the tag name has to be changed or replaced by a new one (possibly caused by a mistake in configuration or failure of a sensor). In some embodiments, when the data access layer accepts a data request from a supervisory information system application, it will map the standard feature name to its actual data source (e.g. tag name) and perform the data access operation though the interface right for that source.

In some embodiments, the plant model can be built from a pre-established template choosing from a template base designed beforehand for different types of power plant. Since designs and constructions of the same type power plants share a high percent of similarity, it is possible to summarize the common aspects, extract the common features and relationships, name them in a systematic and standard manner, organize them into a tree-like structure, and finally form a basic template for the plant model of that type. Final users can choose a template most similar to the real power plant and adapt it to the real construction with only minor modifications or extensions. Note that, since all the templates follow the same naming system, feature names of one template can be identical to feature names of another template provide that they present the same or similar physical meaning.

FIG. 6 is a block diagram illustrating a machine in the example form of a computer system 600, within which a set of sequence of instructions for causing the machine to perform any one of the methodologies discussed herein may be executed.

In some embodiments, the machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions that specify actions to be taken by that machine. Further, while only a single machine is illustrated, the term “machine” shall also be taken to include any collection of machines that individually or jointly execute a set of instructions to perform any one or more of the methodologies discussed herein.

The example computer system 600 includes a processor 602 (e.g., a central processing unit (CPU) a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and electromagnetic signals.

The above-described steps can be implemented using standard programming techniques. The novelty of the above-described embodiment lies not in the specific programming techniques but in the use of the methods described to achieve the described results. Software programming code which embodies the present application is typically stored in permanent storage. In a client/server environment, such software programming code may be stored in storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

As a result of the application, it alleviates information (data) overload that occur during implementation, installation, configuration and maintenance steps of a supervisory information system used in a power plant. Additionally, the smart data access layer described herein enhances data quality and security, improves information sharing and facilitates running advanced applications related to the implementation, installation, configuration and maintenance of the power plant.

While there has been described herein the principles of the application, it is to be understood by those skilled in the art that this description is made only by way of example and not as a limitation to the scope of the application. Accordingly, it is intended by the appended claims, to cover all modifications of the application which fall within the true spirit and scope of the application.

1. A method, comprising
selecting a template characterizing a power plant from a template base, the template base including a plurality of templates;
creating a power plant model of the power plant using the first template, the power plant model including a plurality of modules arranged in a hierarchical tree array having at least one tree branch, wherein each module of the plurality of modules includes a plurality of attributes of the power plant arranged to be accessed by a data access layer using a tag name which includes names of ancestor modules in the tree branch;
mapping at least some of the plurality of attributes to a plurality of operating applications of the power plant using the data access layer; and
configuring the power plant with the plurality of operating applications using the data access layer.

2. The method of claim 1, further comprising:
processing operating data received from the power plant that is associated with the plurality of attributes using a pre-processing/post-processing module included in the data access layer.

3. The method of claim 2, further comprising:
providing the processed operating data from the power plant to at least one supervisory information system application.

4. The method of claim 3, wherein providing the processed operating data from the power plant to at least one supervisory information system application includes providing the processed operating data from the power plant to a data validation application.

5. The method of claim 1, further comprising:
communicating with the power plant using the data access layer and retrieving power plant data and performing calculations on the power plant data for the specific applications of the power plant

6. The method of claim 1, further comprising:
providing access privileges for users to access the power plant model using the data access layer.

7. The method of claim 1, further comprising:
performing unit transformation of power plant operating data using the data access layer, wherein unit transformation includes converting the unit of measurement of power plant data from a first to a second measuring system.

8. The method of claim 1, further comprising:
performing data validation of power plant data received from the power plant using the data access layer to compare the power plant data to a stored data representing valid data.

9. The method of claim 1, wherein configuring the power plant with operating attributes using the data access layer includes using a configuration tool to insert selected attribute data setting at specific power plant locations designated by the power plant model.

10. A system, comprising:
means for creating a power plant model of the power plant using a template, the power plant model including a plurality of modules arranged according to the template in a hierarchical tree array having at least one tree branch, wherein each of the plurality of modules includes operating attributes of the power plant arranged to be accessed by a data access layer using a tag name which includes names of ancestor modules in the tree branch; and
a data access layer to map the plurality of operating attributes to operating applications of the power plant using the data access layer and to configure the power plant with the attributes using the data access layer.

11. The system of claim 10, further comprising:
means for selecting a template characterizing a power plant from a template base, the template base including a plurality of templates;

12. The system of claim 10, further comprising:
a pre-processing/post-processing module included in the data access layer to process data received from the power plant that is associated with the plurality of attributes and provide the processed power plant data to at least one supervisory information system application.

13. The system of claim 10, wherein the data access layer includes the power plant model.

14. The system of claim 10, wherein the data access layer includes a logging system.

15. The system of claim 10, wherein the data access layer includes a data validation system to validate the power plant data.

16. The system of claim 10 wherein the data access layer is configured to perform unit transformation of the power plant data.

17. The system of claim 10, wherein the data access layer includes a data post-processing system.

18. A machine-readable medium comprising instructions, which when implemented by one or more processors, perform the following operations:
selecting a template characterizing a power plant from a template base, the template base including a plurality of templates;
creating a power plant model of the power plant using the first template, the power plant model including a plurality of modules arranged in a hierarchical tree array having at least one tree branch, wherein each of the plurality of modules includes a plurality of attributes of the power plant that are arranged to be accessed by a data access layer using a tag name which includes names of ancestor modules in the tree branch
mapping the plurality of attributes to specific applications of the power plant using the data access layer; and
configuring the power plant with the plurality of attributes using the data access layer.

19. The machine-readable medium of claim 17, further comprising instructions, which when implemented by one or more processors, perform the following operation:
processing data received from the power plant that is associated with the plurality of attributes using a pre-processing/post-processing module included in the data access layer and providing the processed power plant data to at least one supervisory information system application.

20. The computer-readable medium of claim 17, further comprising instructions, which when implemented by one or more processors, perform the following operation:
communicating with the power plant using the data access layer and retrieving power plant data and performing calculations on the power plant data for the specific applications of the power plant.

21. The computer-readable medium of claim 17, further comprising instructions, which when implemented by one or more processors, perform the following operation:
providing access privileges for users to access the power plant model using the data access layer.

22. The computer-readable medium of claim 17, further comprising instructions, which when implemented by one or more processors, perform the following operation:
performing unit transformation of power plant data using the data access layer, wherein unit transformation includes converting the unit of measurement of power plant data between various measuring systems.

23. The computer-readable medium of claim 17, further comprising instructions, which when implemented by one or more processors, perform the following operation:
performing data validation of power plant data received from the power plant using the data access layer to compare the power plant data to a stored data representing valid data.

24. The computer-readable medium of claim 17, wherein configuring the power plant with the plurality of attributes using the data access layer includes using a configuration tool to insert selected attribute data at specific power plant locations designated by the power plant model.
